(19) United States
(12) Patent Application Publication
(10) Pub. No.: US 2021/0150843 A1
(43) Pub. Date: May 20, 2021

(54) SYSTEMS AND METHODS FOR MONITORING A COIN-OPERATED DEVICE

(71) Applicants: Scott D. Sherrod, St. Louis, MO (US); Anthony F. Giordano, St. Louis, MO (US); Richard Paul Hairsine, Ballwin, MO (US)

(72) Inventors: Scott D. Sherrod, St. Louis, MO (US); Anthony F. Giordano, St. Louis, MO (US); Richard Paul Hairsine, Ballwin, MO (US)

(21) Appl. No.: 17/100,604

(22) Filed: Nov. 20, 2020

Related U.S. Application Data
(60) Provisional application No. 62/938,070, filed on Nov. 20, 2019.

(51) Int. Cl. G07F 11/44; G07F 1/02; G07F 5/22; G07D 11/14; G07D 11/22

(52) U.S. Cl. CPC G07F 11/44; G07F 1/02; G07D 11/22; G07D 11/14; G07F 5/22

(57) ABSTRACT

Systems, apparatus, and methods for tracking or monitoring utilization of a coin-operated device without opening the device. The device can be designed, retrofitted, to have an electronic counting system, generally including a small circuit board with a controller, counter, and transceiver. The counting system is also connected to the coin-operated apparatus to detect use, such as by detecting the passage of a coin. The counter is then incremented. The current count can be queried by a mobile device or other computer via the wireless transceiver, and other instructions can be sent, such as to reset the count to zero.

### CROSS-REFERENCE TO RELATED APPLICATIONS

This application claims the benefit of U.S. Prov. Pat. App. Ser. No. 62/938,070, filed Nov. 20, 2019, the entire disclosure of which is incorporated herein by reference.

### BACKGROUND OF THE INVENTION

### Field of the Invention

This disclosure is related to the field of vending machines. In particular, it relates to systems and methods for monitoring sales or other activity in connection with a coin-operated vending machine.

### Description of the Related Art

Modern vending machines are ubiquitous and merchandise now can be purchased from them using a payment card or a mobile device application. A payment card is used by swiping one's card through a card reader in the machine. A user interface is then manipulated to indicate which item the purchaser wishes to acquire. The payment is then processed using a telecommunications network and, if the transaction is approved, the merchandise is dispensed. Similarly, a mobile device application may be used to place an order and pay for the merchandise. All of this is enabled through the use of computer network technology.

These modern vending machines are the latest iteration of a very old technology. Prior to the introduction of network-enabled vending machines, such devices were typically operated via currency. Such prior-generation vending machines could accept a flattened note in various denominations, and had a coin slot which could accept various types of coins. The purchaser would insert sufficient currency to the machine to establish a credit balance in excess of the purchase price of the merchandise desired, manipulate a set of controls to indicate which item he wished to acquire, and a simple state machine logic, often hardwired, would process the transaction, confirm that sufficient currency had been deposited, operate the machine to dispense the desired item, and issue change if applicable.

Prior to this type of vending machine, bulk vending technologies used simple coin operations. No change was dispensed, the user simply inserted one coin, turned a dial, and received one item from a bin of items. Perhaps the most recognizable type of bulk vending machine in this category is the gumball machine. An embodiment of a prior art bulk vending machine is shown in FIGS. 1A and 1B. FIG. 1A depicts an exploded view of a prior art bulk vending machine, showing the major components used to dispense product in response to a coin being inserted. The depicted embodiment (101) includes a handle (103), a coin receiving disk (105), and a spur gear (107). Also shown is a dispensing disk (109), a delivery shoot (111), and a storage container (113). The device is operated by a user inserting a coin in to a receiving slot in the coin receiving disk (105), and rotating the coin receiving disk (105) and spur gear (107) by turning the attached handle (103). The axle (102) is sized and shaped to cause the coin receiving disk (105) and spur gear (107) to rotate with the handle (103). The spur gear (107) is configured to interact with corresponding teeth on the dispensing disk (109). A full rotation of the handle (103) causes a single dispensing rotation of the dispensing disk (109). A product disposed in one of the compartments of the dispensing disk (109) is then rotated over the top of the chute (111), and gravity pulls the product down and out of the bulk vending machine. The bulk products are stored in the container (113) located above the dispensing disk (109), and gravity pulls one product at a time from the container (113) in to the dispensing disk (109).

To better understand how the coin mechanism works, FIG. 1B depicts an assembled mechanism from the back. As shown in FIG. 1B, the dispensing mechanism consists of a face plate (117) attached to a back plate (119), and the coin dispensing disk (105) is disposed there between. Disposed between the back plate (19) and spur gear (107) is a ratchet gear (115) which interacts with a pawl (125) to inhibit reverse motion of the assembled coin mechanism. A stop (123) is disposed on the back plate (119), and inhibits rotation of the coin receiving disk (105) unless a coin has been inserted in to the coin slot. If a coin is in place, the stop (123) is pushed back towards the anterior of the device, allowing the coin receiving disk (105) to rotate. As the coin receiving disk rotates around, the coin slides out of place via gravity along a ramp (121), where it is deposited in to a coin bin. The user then simply continues forward rotation until the handle is back at its starting position, and a product has been dispensed.

These simple bulk vending devices, although technologically outpaced by their network-enabled descendants, nevertheless remain popular. Grocery stores, barbershops, and children's entertainment centers continue to stock bulk vending machines, which dispense everything from candy to plastic toys to temporary tattoos. Although these machines are simple, intuitive, and nostalgic, they are not without their downsides. In particular, because the internal mechanics are simple and include no electrical parts, it is difficult for a venue to determine whether the bulk vending machine is profitable, or to what degree. For example, other than conducting a visual inspection at some set frequency, and estimating the amount of merchandise remaining, there is no way to know how many people have used the bulk vending machine without opening it. Moreover, this defeats part of the advantage of having such machines, which is that they are low maintenance and require little direct management or oversight.

This issue is not limited to bulk vending machines. Other coin-operated machines suffer similar shortcomings. For example, classic arcade cabinets generally have an internal counter for the number of quarters that have been deposited, but there is no way to determine the utilization count from outside the machine. For a venue monitoring a large number of devices, it is not practical to open each device each day to track usage. This in turn means that the amount of available data and analytics is coarse, and may not be available on a frequent basis. In some instances, it may be impractical to track utilization more than quarterly or annually.

### SUMMARY OF THE INVENTION

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Because of these and other problems in the art, described herein, among other things, is a coin-operated dispensing apparatus comprising: a disk having a recess sized and shaped to retain a coin; an axle disposed through and rotatably connected to the disk; a handle fixedly connected to a first end of the axle; a spur gear disposed at a second end of the axle opposing the first end; a dispensing disk intermeshed with the spur gear; and a counting system comprising: a controller; a detector operatively coupled to the controller and adapted to detect each use of the coin-operated dispensing apparatus; and a non-transitory computer-readable storage medium operatively coupled to the controller and having stored thereon a count of uses of the coin-operating dispensing apparatus; wherein when a coin is placed in the recess and the handle is rotated, the disk rotates to deposit the coin to travel on coin ramp and trigger the detector, the triggered detector causing the controller to increment the count of uses in the storage medium.

In an embodiment of the coin-operated dispensing apparatus, the counting system further comprises a wireless transceiver operatively coupled to the controller.

In another embodiment of the coin-operated dispensing apparatus, when the triggered detector causes the transceiver to transmit the incremented count of uses.

In another embodiment of the coin-operated dispensing apparatus, when the triggered detector causes the controller to cause the transceiver to transmit the incremented count of uses via a wireless network.

In another embodiment of the coin-operated dispensing apparatus, the detector comprises a motion sensor.

In another embodiment of the coin-operated dispensing apparatus, the detector comprises a trigger-operated mechanical counter.

In another embodiment of the coin-operated dispensing apparatus, the controller is operatively coupled to the detector and to the storage medium via a circuit board affixed to a first side of the coin-operated dispensing apparatus.

Also described herein, among other things is a bulk vending machine including the coin-operated dispensing apparatus and having a storage container attached to a body thereof, the storage container having an open bottom end disposed at the dispensing disk.

In an embodiment of the bulk vending machine of claim 9, the coin-operated dispensing apparatus comprises a second side opposing the first side, and the first side is disposed within the body.

Also described herein, among other things, is a method for monitoring a coin-operated device comprising: providing a coin-operated dispensing apparatus comprising: a disk having a recess sized and shaped to retain a coin; an axle disposed through and rotatably connected to the disk; a handle fixedly connected to a first end of the axle; a spur gear disposed at a second end of the axle opposing the first end; a dispensing disk intermeshed with the spur gear, and a counting system comprising: a controller; a detector operatively coupled to the controller and adapted to detect each use of the coin-operated dispensing apparatus; a non-transitory computer-readable storage medium operatively coupled to the controller and having stored thereon a count of uses of the coin-operating dispensing apparatus; and a wireless transceiver operatively coupled to the controller; receiving a coin in the recess; rotating the handle one revolution; the rotating handle causing the disk to rotate and deposit the coin to travel on a coin romp and trigger the detector; and the triggered detector causing the controller to increment the count of uses in the storage medium and the triggered detector causing the controller to cause the transceiver to transmit the incremented count of uses.

In an embodiment of the method, the transmitted incremented count of uses is transmitted via a wireless network.

In another embodiment of the method, the transmitted incremented count of uses is transmitted to a computer via the wireless network.

In another embodiment of the method, the computer is a server computer.

In another embodiment of the method, the computer is a mobile device.

In another embodiment of the method, the method further comprises the mobile device displaying on a display thereof the incremented count of users

in another embodiment of the method, the method further comprises: receiving, at the wireless transceiver via the wireless network, data comprising an instruction to reset the counter; and in response to the receiving, the controller causing the stored count of uses to be reset to zero.

In another embodiment of the method, the data comprising an instruction to reset the counter is received from a mobile device.

In another embodiment of the method, the method further comprises: receiving, at the wireless transceiver via the wireless network, data comprising a count query; and in response to the receiving, the controller causing the transmitter to transmit via the wireless network the current value of the stored count of uses.

In another embodiment of the method, the data comprising an instruction to reset the counter is received from a mobile device.

In another embodiment of the method, the coin-operated dispensing apparatus is installed on a bulk vending machine having a storage container attached to a body thereof, the storage container having an open bottom end disposed at the dispensing disk, and the rotating the handle one revolution causes the bulk vending machine to vend a product stored in the storage container.

### BRIEF DESCRIPTION OF THE DRAWINGS

FIG. 1A provides an exploded view of an embodiment of a prior art bulk vending machine.

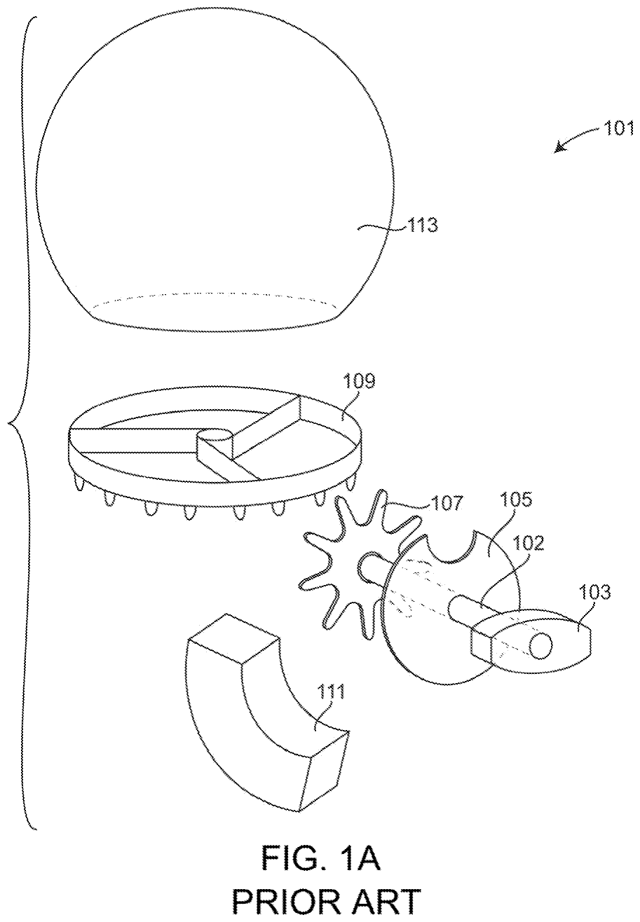

FIG. 1B provides a back perspective view of an embodiment of a prior art bulk vending machine coin accepting mechanism.

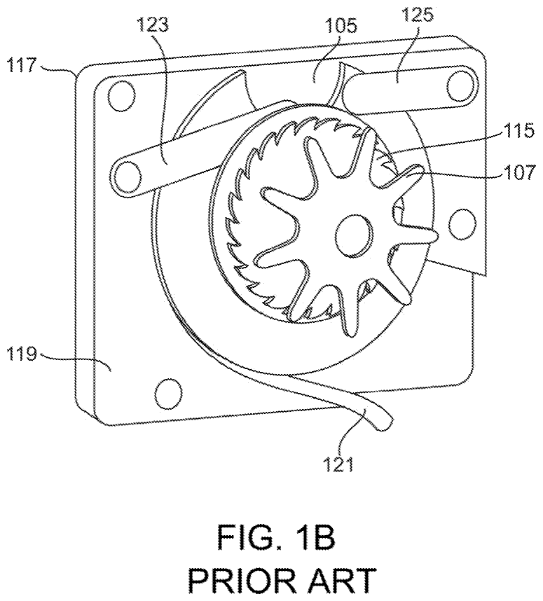

FIG. 2A provides a back perspective view of an embodiment of a bulk vending machine coin accepting mechanism modified for remotely monitoring usage of a bulk vending machine as described herein.

FIG. 2B provides a schematic diagram of an embodiment of a circuit board of a system for remotely monitoring usage of a bulk vending machine as described herein.

FIG. 3 provides a diagram of an embodiment of a system for remotely monitoring usage of a bulk vending machine as described herein.

FIG. 4 provides a flow chart of an embodiment of a method for remotely monitoring usage of a bulk vending machine as described herein.

### DESCRIPTION OF THE PREFERRED EMBODIMENT(S)

The following detailed description and disclosure illustrates byway of example and not by way of limitation. This description will clearly enable one skilled in the art to make and use the disclosed systems and methods, and describes several embodiments, adaptations, variations, alternatives and uses of the disclosed systems and methods. As various changes could be made in the above constructions without departing from the scope of the disclosures, it is intended that all matter contained in the description or shown in the accompanying drawings shall be interpreted as illustrative and not in a limiting sense.

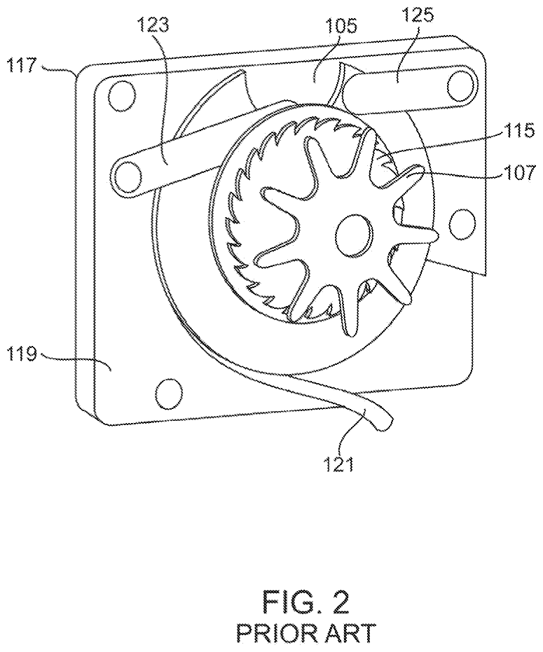

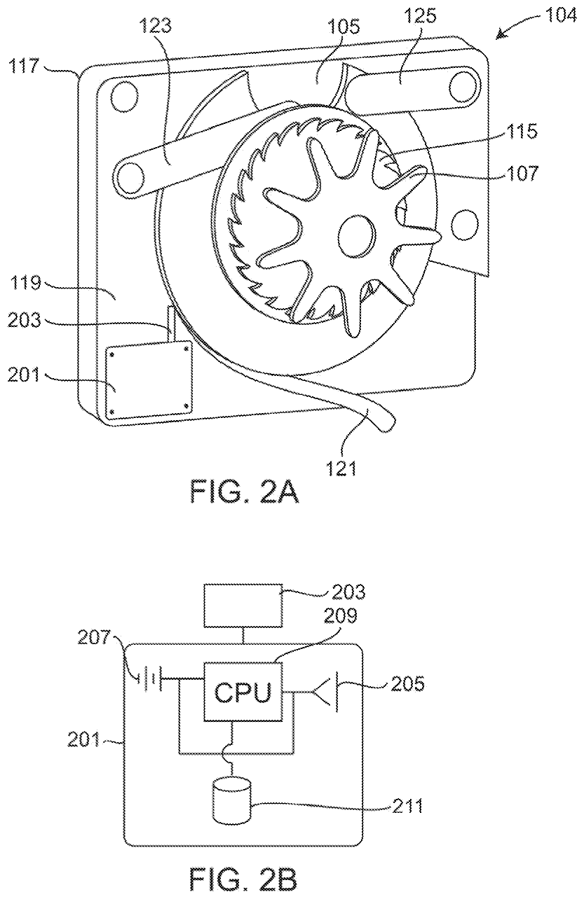

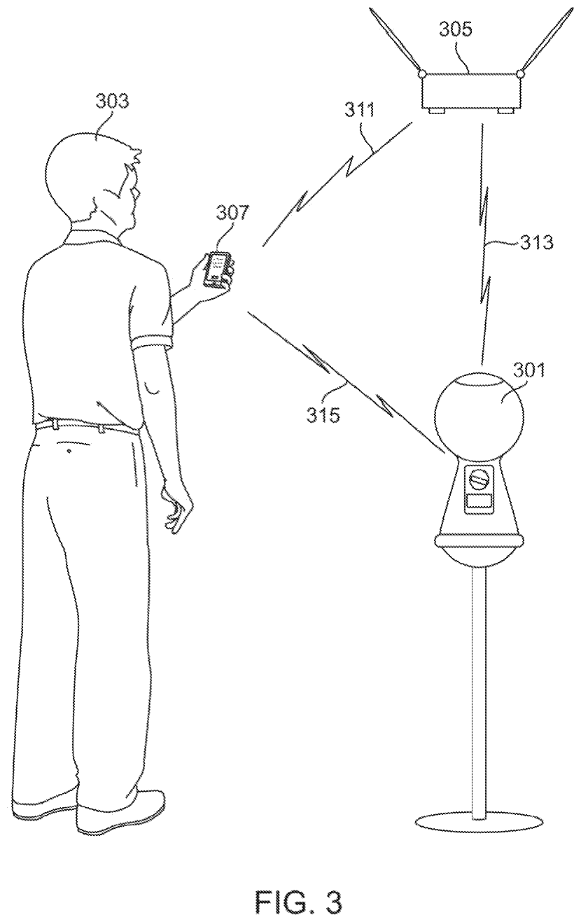

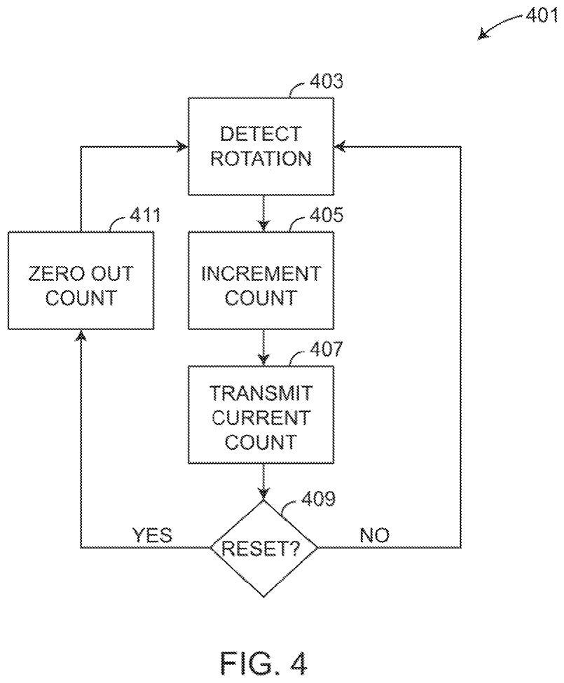

Because of these and other problems in the art, described herein, among other things, are systems, apparatus, and methods for tracking or monitoring utilization of a coin-operated device without opening the device. FIGS. 2A, 2, 3, and 4 depict non-limiting, exemplary embodiments of such systems, apparatus, and methods. The present disclosure is generally contemplated for use with mechanical coin-operated machines, such as bulk vending machines (e.g., gumball machines), or any other coin-operated device where the device itself does not readily provide a mechanism for accurately counting utilization without manual intervention, such as by opening the device. Such devices may include video game cabinets, jukeboxes, gas station air compressors, coin-operated car washes and vacuums, pinball machines, pool tables, cigarette machines, food and beverage bulk vending machines, and so forth.

At a high level, the systems and methods described herein retrofit to an existing coin-operated device (301) a small circuit board (201) equipped with an apparatus (203) for detecting (403) one revolution of the coin-operated mechanism (104), incrementing (405) a count of such revolutions, and transmitting (401) that count wirelessly to an external device, generally by use of a short-range radio transmitter (205). A person of ordinary skill in the art will further appreciate that the circuit board (201) will comprise other circuitry for carrying out these tasks, including, but not limited to, a power supply (207) and associated circuitry (e.g., a chemical cell or other battery or other renewable source of power), a transmitter (205) or transceiver (205), a controller (209) or microprocessor (209), and other appropriate electrical components.

When a user puts a coin into the coin acceptor (105), and spins the handle (103), a detection apparatus (203) is activated which will send a signal to a controller (209) or microprocessor (209). The controller (209) detects the revolution (402) and interprets the signal as indicating a revolution, and increments (405) a count of revolutions. This count may be stored in a storage (211) of any kind now known in the art or in the future developed.

The detection apparatus (203) may be any known in the art to detect a full spin of the handle, many of which are known in the art and will be familiar to a person of ordinary skill in the art. For example, a motion sensor could be placed to detect the passage of a vended product to the customer, or the passage of the coin, ensuring that the spin is associated with a successful sale. Alternative, some vending machines have coin counters, which are mechanical counters incremented by one each time a mechanical switch is triggered. These counters are placed in the deposit path of the coin and incremented each time a coin passes. Such a counter could be adapted or repurposed to provide an electric signal back to the circuit board upon the triggering of the switch, or a similar special-purpose device usually simple mechanical switches triggered by the passing the coin and cause a mechanical counter to increment by one. Alternatively, the detection apparatus could include mechanical elements connected to one or more of the spur gear (107), stop (123), pawl (125), or other mechanical components to detect a vending event based on the movement of these or other components.

In an embodiment, the count is incremented continuously, but in another embodiment, the count may be reset (409) as described herein. After some period of time, an employee (303) or other person (303) acting on behalf of the venue or entity which wishes to monitor the use of the device (301) will approach the device (301) with a radio-enabled reader (307) in hand. A simple way to do this may be to develop a mobile device application which uses the Bluetooth transceiver in a common mobile phone (307) to connect to the radio transmitter (205) in the coin-operated device (301), such as through pairing (315) as known in the art, but a special purpose or other type of device (307) could be used. For example, a handheld scanner may be used, or a longer-range radio transceiver (305) in a fixed location could be used. This external radio transmitter (305) could send a signal to the transceiver (205) on the circuit board (201) indicating that the spin count is desired. The radio transceiver (205) then retrieves the current count of revolutions from the memory (211), generally through use of the controller (209), and the current revolution count is then transmitted (407) by the radio transceiver (205) on the chip (201) to the connected external radio transmitter (305). This value may then be used for whatever business purpose is necessary. Typically, the value may be displayed to the user via a display of the mobile device (307), or otherwise retransmitted or stored to keep track of the count. In some embodiments, the stored count may be reset to zero (411). This may be done by default anytime the radio transmitter sends the value, or may be specifically requested (409) by the external transmitter.

The circuit board (201) is generally sized and shaped, and the circuitry and components laid out, so that the board (201) is as small as possible and may be retrofitted onto the back plate (201) of the bulk vending machine. This minimizes the requirement for new parts or components, and allows for maximum utilization of the invention.

In an embodiment, an external network (305) may continuously monitor the count. This may be done by periodically pinging the transceiver on the circuit board to acquire an updated count.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

1. A coin-operated dispensing apparatus comprising:
a disk having a recess sized and shaped to retain a coin;
an axle disposed through and rotatably connected to said disk;
a handle fixedly connected to a first end of said axle;
a spur gear disposed at a second end of said axle opposing said first end;
a dispensing disk intermeshed with said spur gear; and
a counting system comprising:
a controller;
a detector operatively coupled to said controller and adapted to detect each use of said coin-operated dispensing apparatus; and
a non-transitory computer-readable storage medium operatively coupled to said controller and having stored thereon a count of uses of said coin-operating dispensing apparatus;
wherein when a coin is placed in said recess and said handle is rotated, said disk rotates to deposit said coin to travel on coin ramp and trigger said detector, said triggered detector causing said controller to increment said count of uses in said storage medium.

2. The coin-operated dispensing apparatus of claim 1, wherein said counting system further comprises a wireless transceiver operatively coupled to said controller.

3. The coin-operated dispensing apparatus of claim 2, wherein when said triggered detector causes said transceiver to transmit said incremented count of uses.

4. The coin-operated dispensing apparatus of claim 3, wherein when said triggered detector causes said controller to cause said transceiver to transmit said incremented count of uses via a wireless network.

5. The coin-operated dispensing apparatus of claim 1, wherein said detector comprises a motion sensor.

6. The coin-operated dispensing apparatus of claim 1, wherein said detector comprises a trigger-operated mechanical counter.

7. The coin-operated dispensing apparatus of claim 1, wherein said controller is operatively coupled to said detector and to said storage medium via a circuit board affixed to a first side of said coin-operated dispensing apparatus.

8. A bulk vending machine including said coin-operated dispensing apparatus of claim 1 and having a storage container attached to a body thereof, said storage container having an open bottom end disposed at said dispensing disk.

9. The bulk vending machine of claim 9, wherein said coin-operated dispensing apparatus comprises a second side opposing said first side, and said first side is disposed within said body.

10. A method for monitoring a coin-operated device comprising:
providing a coin-operated dispensing apparatus comprising:
a disk having a recess sized and shaped to retain a coin;
an axle disposed through and rotatably connected to said disk;
a handle fixedly connected to a first end of said axle;
a spur gear disposed at a second end of said axle opposing said first end;
a dispensing disk intermeshed with said spur gear; and
a counting system comprising:
a controller;
a detector operatively coupled to said controller and adapted to detect each use of said coin-operated dispensing apparatus;
a non-transitory computer-readable storage medium operatively coupled to said controller and having stored thereon a count of uses of said coin-operating dispensing apparatus; and
a wireless transceiver operatively coupled to said controller;
receiving a coin in said recess;
rotating said handle one revolution;
said rotating handle causing said disk to rotate and deposit said coin to travel on a coin ramp and trigger said detector; and
said triggered detector causing said controller to increment said count of uses in said storage medium and said triggered detector causing said controller to cause said transceiver to transmit said incremented count of uses.

11. The method of claim 12, wherein when said transmitted incremented count of uses is transmitted via a wireless network.

12. The method of claim 11, wherein said transmitted incremented count of uses is transmitted to a computer via said wireless network.

13. The method of claim 12, wherein said computer is a server computer.

14. The method of claim 12, wherein said computer is a mobile device.

15. The method of claim 14, further comprising said mobile device displaying on a display thereof said incremented count of users

16. The method of claim 10, further comprising:
receiving, at said wireless transceiver via said wireless network, data comprising an instruction to reset said counter; and
in response to said receiving, said controller causing said stored count of uses to be reset to zero.

17. The method of claim 16, wherein said data comprising an instruction to reset said counter is received from a mobile device.

18. The method of claim 10, further comprising:
receiving, at said wireless transceiver via said wireless network, data comprising a count query; and
in response to said receiving, said controller causing said transmitter to transmit via said wireless network the current value of said stored count of uses.

19. The method of claim 18, wherein said data comprising an instruction to reset said counter is received from a mobile device.

20. The method of claim 10, wherein said coin-operated dispensing apparatus is installed on a bulk vending machine having a storage container attached to a body thereof said storage container having an open bottom end disposed at said dispensing disk, and said rotating said handle one revolution causes said bulk vending machine to vend a product stored in said storage container.
